(19) United States
(12) Patent Application Publication
(10) Pub. No.: US 2011/0098981 A1
(43) Pub. Date: Apr. 28, 2011

(54) METHOD AND APPARATUS FOR PROCESSING MEASURED VALUES OF PARAMETERS OF A TELECOMMUNICATION NETWORK

(76) Inventor: Hanspeter Bobst, Oensingen (CH)

(21) Appl. No.: 12/999,103

(22) PCT Filed: Jun. 20, 2008
(86) PCT No.: PCT/CH2008/000279

§ 371 Date: Dec. 15, 2010

(51) Int. Cl. G06F 15/00

(52) U.S. Cl. 702/190

(57) ABSTRACT

The present invention relates to a method for processing measured values of parameters of a telecommunication network, wherein the measured values are filtered by a filter unit (30, 31, 32, 33; 300, 22 330) and wherein the filter unit (30, 31, 32, 33; 300, 330) is selected from a set of filter units (40; 54) in dependence on the occurrence and the nature of a network event. The invention relates furthermore to an apparatus (51) for processing measured values of parameters of a telecommunication network, wherein a set of filter units (40; 54) is provided for filtering the measured values in dependence on the occurrence and the nature of a network event.

### TECHNICAL FIELD

The invention relates to a method for processing measured values of parameters of a telecommunication network according to the preamble of claim 1 and to an apparatus for processing measured values of parameters of a telecommunication network according to the preamble of claim 9.

### BACKGROUND

Determining the quality of a telecommunication network, e.g. a mobile network, usually serves as a basis for improving the network quality and thereby enhancing the revenue of the network provider. Typically about 90% to 95% of a telecommunication network are of good quality, whereas the remaining 5% to 10% are in need of repair or improvement. Problems exist with respect to time, a position within the network or a particular application.

FIG. 1 depicts a typical measurement setup 1 for determining the quality of a telecommunication network. Parameters of the telecommunication network are measured by measurement probes 3, 5. The quality of the network can then be derived or determined from the measured values of the parameters. Typically there are about several hundred different parameters. The parameters are usually attributed to different interconnection layers. A layer is a collection of related functions that provide services to the layer above and receives services from the layer below (e.g. http://en.wikipedia.org/wiki/OSI_model). Parameters related to the lowest layer are typically, for example, signal level, bit error rate, and channel number. Parameters associated with the next layer are typically, for example, protocol data, connection establishment, connection termination, and handover. Parameters attributed to the application layer are, for example, speech quality, video quality, data quality, and data through-put (for example when testing a browser). Further auxiliary parameters are typically used, such as the position of a measurement probe 3, 5 as determined by GPS (Global Positioning System).

The measurement setup 1 of FIG. 1 comprises at least one measurement device 2 and a measurement probe 3. The measurement device 2 and the measurement probe 3 can coexist on the same hardware. For example, the application software for the measurement probe 3 may run on a smart phone device representing the measurement device 2. This is e.g. the case with the application “QualiPoc” from SwissQual. The measurement device 2 can for example be a mobile phone, a data card, a GPS receiver, a RF (Radio Frequency) scanner or similar. The measuring probe 3 is for example a computer or a device performing the functions of a computer. On the measurement probe 3 is implemented appropriate software, i.e. an appropriate application program, for controlling the measurement device 2 such that so-called test sequence control and data acquisition can be performed. Test sequence control comprises for example call control and data session control. Call control allows for the establishment and termination of test connections with a second measurement probe 5 and its associated measurement device 4 via a channel 6, thereby testing the channel 6. The second measurement device 4 functions as answer device. Of course, evaluation of the channel 6 is also possible by means of just one measurement probe 3, i.e. single endedly, this being for example the case with so-called diversity optimizers. Examples of products that perform test sequence control are e.g. the “Diversity” products and the “QualiPoc” products from SwissQual.

Values of the parameters of the network can then be measured via the measurement devices 2, 4 by the measurement probes 3, 5 with the measurement probes 3, 5 calling each other and thereby exchanging test sequences. The measured values represent the measurement results and they are written typically together with time stamps and GPS-data/positions in measurement files 7, 8 and stored e.g. on a hard disk. In FIG. 1 box 12.1 represents the actual taking of the measured values of the parameters and box 12.2 represents the processing of the measured values.

A user of the measurement setup can view the measurement results in real-time via a so-called replay tool or offline in offline mode. For offline viewing the measurement results are uploaded via an upload channel 9 or simply copied “by hand” (e.g. via an USB-Stick, a DVD or similar) from the measurement probe 3/measurement device 2 to an offline analysis tool and typically stored in a database 10 or in one or more data files before the measurement results are analyzed. If they are stored in a data file they can also be viewed by means of a replay tool. Reports and statistics 11 can then be generated from the database entries or the data file(s) and appropriately presented. As the measurement results are stored in a database or data file, historical data can be extracted and reports and statistics can be generated that give a historical perspective. Hence, the user can compare the latest measurement results with former measurement results.

For modern telecommunication systems like for example UMTS (Universal Mobile Telecommunications System) the measurement setup 1 depicted in FIG. 1 typically generates as measured values/measurement results about 100 Mbytes of data per hour and per measurement device. Such a large amount of data often causes several problems: It floods the local hard disk in a short time. Furthermore, to transfer such an amount of data into a database the upload channel 9 is required to have a large bandwidth and the transferal often takes quite a long time. Also the rate at which the reports and statistics 11 are generated from the measurement results depends on the amount of data. However, often not all details regarding the measured values are actually required as typically about 90% of a telecommunication network are in good quality. The measured values are usually only required for the faulty 10% of a telecommunication network.

To reduce the amount of data standard compression algorithms such as ZIP can be used. ZIP and similar tools work as lossless algorithms (i.e. they constitute reversible processes) and are therefore limited in achieving high compression ratios. Another way of data reduction is to neglect certain parameters of less importance of one or more interconnection layers of a telecommunication network. However, a reduction achieved in this way is often not sufficient and/or may lead to less accurate network quality evaluation and/or a total loss of relevant data required for later network optimization.

### DISCLOSURE OF THE INVENTION

It is an object of the invention to provide a method and an apparatus for processing measured values of parameters of a telecommunication network by which the amount of measurement data can be reduced, in particular with negligible effect to typical network quality evaluation.

In order to implement these and still further objects of the invention, which will become more readily apparent as the description proceeds, a method for processing measured values of parameters of a telecommunication network is provided, wherein the measured values are filtered by a filter unit, which is selected from a set of filter units in dependence on the occurrence and the nature of a network event. Preferentially, the measured values are filtered by the filter unit such that the measured values of certain parameters are held back. The parameters corresponding to the measured values that are held back (and hence the parameters corresponding to the measured values that are let pass) are selected in dependence on the occurrence and the nature of the network event.

A network event is in particular a critical situation like a fault, i.e. a situation impeding the proper functioning of the telecommunication network. A network event may, however, also be an artificially created situation like a test scenario.

Preferentially, the filtered measured values are furthermore compressed by a compression unit, which is selected from a set of compression units in dependence on the occurrence and the nature of the network event. The compression of the filtered measured values can be such that the resolution of the filtered measured values is reduced. Preferably, averaging is used for compressing the filtered measured values.

For the detection of a network event (i.e. its occurrence and nature) key performance indicators are preferentially defined and their actual values are determined. A network event is detected if an actual value of a key performance indicator deviates from a predefined target value. The target value may also be called set point value or reference value for example.

The method according to the invention can be implemented on a measurement probe 3, 5 as described in connection with FIG. 1.

The apparatus according to the invention comprises a set of filter units for filtering the measured values of the parameters in dependence on the occurrence and nature of a network event. The apparatus of the invention may be realized as software and/or hardware component. The filter units are preferably formed/designed such that the measured values of certain parameters are held back. The parameters corresponding to the measured values that are held back (and hence the parameters corresponding to the measured values that are let pass) are selected in dependence on the occurrence and the nature of the network event. The filter units may be realized as software and/or as hardware components.

Preferentially, the apparatus according to the invention comprises furthermore a set of compression units for compressing the filtered measured values in dependence on the occurrence and the nature of a network event. The compression units are preferably formed/designed such that they perform averaging of the filtered measured values. The compression units may be realized as software and/or hardware components.

As mentioned above different test scenarios for a telecommunication network may correspond to different network events. Each test scenario may serve a different aim, e.g. there may be test scenarios used for analyzing a network with respect to benchmarking, service monitoring, optimization or similar. All or some of the test scenarios may not require the measured values of all parameters of the telecommunication network in question. Hence, a set of filter units is defined with each filter unit being associated to one test scenario, so that the measured values of the parameters are filtered in dependence on the occurrence and the nature of the test scenario which advantageously leads to data reduction.

In the case of the network event being a critical situation, e.g. a network fault, then depending on the particular network event (i.e. its nature) the filter unit is selected for filtering the measured values of the parameters of the telecommunication network such that only the measured values of parameters, which are relevant for the particular network event are let pass as only those are of interest for analysing the telecommunication network with respect to the particular network event that occurred. Measured values of non-relevant parameters are held back by the selected filter unit. The measured values of the relevant parameters are preferably let pass without compression in the time domain. I.e. if a network event occurs it is switched from a standard filter unit, which is employed when no network event is detected, to a particular network event filter unit, which is defined at the beginning of the test scenario and in compliance with the particular test scenario. It may be advantageous to additionally let pass further measured values of parameters to obtain more information for analysing the network event, in particular a network fault.

The selected filter unit is valid and employed during a predetermined time interval around the network event, for example a couple of seconds before the occurrence of the network event until a couple of seconds after the occurrence of the network event. Therefor the measured values of the parameters are buffered, i.e. stored in a temporary buffer store. Hence, the writing of filtered measured values onto a hard disk or another storage medium takes place somewhat delayed when compared to real-time to allow for the filtering of measured values of the parameters which are measured a couple of seconds before the network event.

After the network event has ended, i.e. the critical situation/phase is over, a different filter unit is preferentially selected from the set of filter units, which preferably is the standard filter unit selected when no network events occur, i.e. the telecommunication network functions properly. The standard filter unit is designed such that the amount of measured values of the parameters is reduced considerably and preferably more than with the remaining filter units of the set of filter units. Hence, the set of filter units comprises a standard filter unit and at least one filter unit for at least one network event. The standard filter unit is also called default filter unit.

### BRIEF DESCRIPTION OF THE DRAWINGS

Further advantageous features and applications of the invention can be found in the dependent claims as well as in the following description of the drawings illustrating the invention. In the drawings like reference signs designate the same or similar parts throughout the several figures of which:

FIG. 1 shows a schematic representation of a measurement setup according to the state of the art,

FIG. 2 shows a flowchart of the method according to the invention,

FIG. 3 shows a schematic representation of a filtering device representing a set of filter units of an apparatus according to the invention,

FIG. 4 shows a flowchart of the method according to the invention which is exemplarily adapted to the network event “pilot pollution” and

FIG. 5 shows a schematic representation of a measurement setup with an apparatus according to the invention.

### MODE(S) FOR CARRYING OUT THE INVENTION

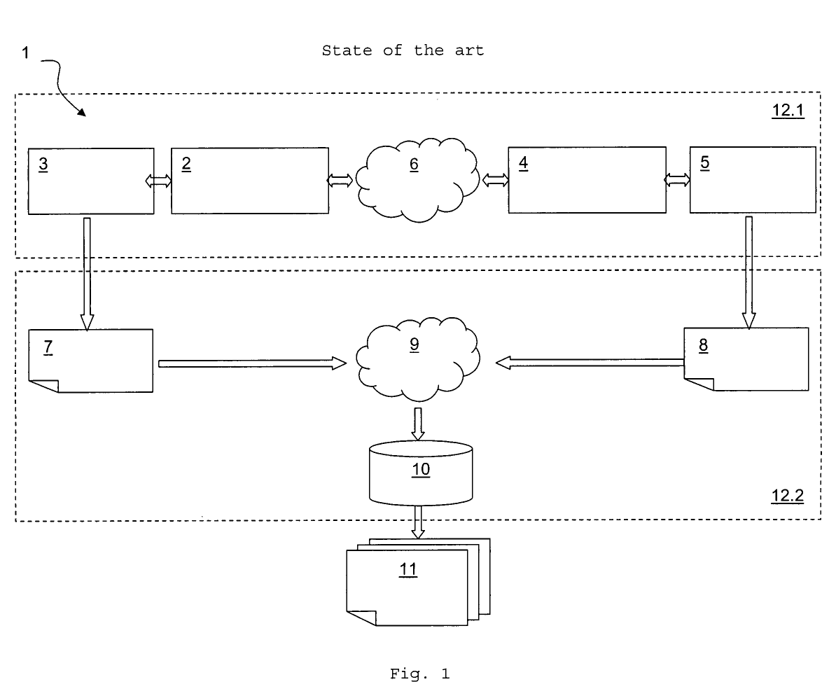

FIG. 1 has been described in the introductory part of the specification and it is referred thereto.

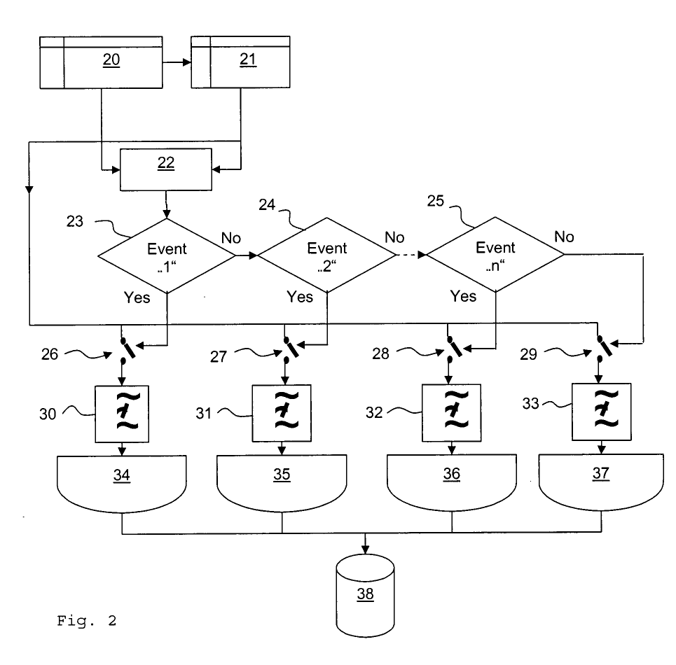

FIG. 2 shows a flowchart representing the method of the invention. In a first step 20 measurements of parameters of a telecommunication network are taken leading to measured values of the parameters. The measured values are in a subsequent step 22 evaluated for the occurrence of network events. During evaluation also the nature of a detected network event is determined. The evaluation of the measured values takes preferentially place before the measured values are forwarded to and stored in a database, a data file and/or on a storage medium as e.g. a hard disk. I.e. a preliminary analysis of the measured values is performed before they are stored in a database, a data file and/or on a storage medium. For the preliminary analysis the measured values are preferably stored in a temporary buffer store.

For the detection of network events key performance indicators (KPI) are preferably defined, for example by network operators. By means of the key performance indicators the quality of a telecommunication network can be described. Key performance indicators are specific parameters of a telecommunication network for example handover quality, call quality, through-put quality, speech quality, video quality, bit error rate or similar.

In step 21 the actual values of the defined key performance indicators are measured/determined. For network event detection in step 22, the actual values of the key performance indicators are compared with predefined target values. If the actual value of a key performance indicator deviates from its predefined target value then a network event is detected, the nature of the network event depending on the key performance indicator and/or on the particular deviation from its target value.

For example, if the actual value of the key performance indicator “handover quality” lies below a predefined target value then the network event “handover failure” is detected, i.e. the handover between different network cells failed, which is a network fault. If the actual value of the key performance indicator “bit error rate” lies above a predefined target value then the network event “high bit error rate” is detected, which means the telecommunication network is erroneous. If the actual value of the key performance indicator “speech quality” is below a predefined target value, then the network event “poor speech quality” is detected, which also means that the telecommunication network is erroneous. If the actual value of the key performance indicator “call quality” deviates from a target value, then depending on the deviation one of the network events “call drop” or “call failure” is detected. Further network events such as undesired interference can be detected. The actual values of the key performance indicators are preferably calculated by means of a measurement probe 3, 5 as depicted in FIG. 1 but may also be calculated after the measured values have been transferred to a database/storage medium. Of course, the detection of networks events may be performed by other means than the key performance indicators.

Depending on the occurrence of a detected network event and on the nature of a possibly detected network event the measured values of the parameters of the telecommunication network are filtered by a filter unit 30, 31, 32, 33 and compressed by a compression unit 34, 35, 36, 37. The filter units 30, 31, 32, 33 represent a set of filter units. The compression units 34, 35, 36, 37 represent a set of compression units. In decision steps 23, 24, 25 it is checked for each possible network event “1”, “2”, . . . , “n” if it occurred. If a network event “1”, “2”, . . . , “n” is detected, then the corresponding switch 26, 27, 28 is closed so that the measured values are directed to the associated filter unit 30, 31, 32. If basically no network event has occurred, then the switch 29 is closed, thereby directing the measured values to the default filter unit 33 which is followed by the default compression unit 37. This last-mentioned case corresponds to the case where the actual key performance indicators basically do not deviate from their target values. For this last-mentioned case it can be assumed that the user is not interested in all measured values. Passing through the default filter unit 33 and the default compression unit 37 preferably leads to a higher data reduction then passing through one of the filter units 30, 31, 32 and one of the compression units 34, 35, 36 which are associated with a network event. Of course, the compression units 34, 35, 36, 37 may be omitted if less data reduction is required. The switches 26, 27, 28, 29 may be realized as software and/or hardware components.

The compression units 34, 35, 36, 37 preferentially perform averaging in the time domain. For example, measured values of a parameter that have been taken every 250 milliseconds are averaged over 5 seconds, leading to a compression rate of 20. The compression performed by the compression units can also be such that the resolution of the filtered measured values in the time domain and/or in the spatial domain is reduced. For compressing measured values corresponding to audio and/or video digital data, for example, an MPEG-4 compression method can be used. Measured values corresponding to GPS-positions can be compressed by deleting measured values of the same position taken at different time instances thereby decreasing resolution in the time domain. Of course, each of the compression units 34, 35, 36, 37 may represent several successively performed compressions.

The filtered and compressed measured values of the parameters can then be stored in a database 38 and/or a storage medium as a hard disk. Without the preliminary analysis for network event detection and the filter units 30, 31, 32, 33, the measured values of all parameters would be transferred to the database 38 and/or the storage medium as the measured values would have not been analyzed with respect to those parameters of which measured values are actually required for a later analysis. This leads to more storage space being required for storing the measured values.

With the preliminary analysis for network event detection and the following selective filtering, the amount of measured values is selectively reduced depending on the occurrence and the nature of network events. This leads to a reduction of the required storage space. Furthermore, the transferal of the filtered and optionally compressed measured values to the database 38 and/or the storage medium takes advantageously less time then the transferal of the unfiltered measured values would take.

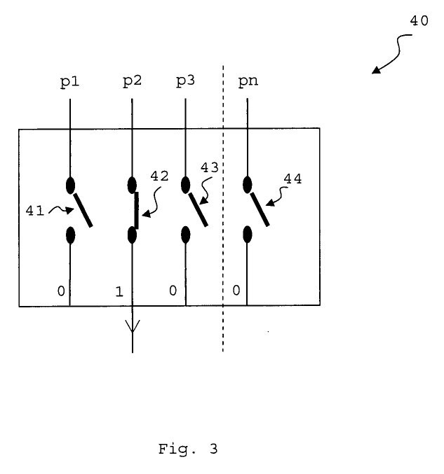

FIG. 3 shows a schematic representation of a filtering device 40, with which a set of filter units 30, 31, 32, 33 as depicted in FIG. 2 can be realized. The filtering device 40 may be implemented as software and/or hardware component. The filtering device 40 comprises switches 41, 42, 43, 44. Exemplarily only four switches 41, 42, 43, 44 are depicted. Of course the filtering device 40 may comprise more than four switches as indicated by the dashed line. Each switch 41, 42, 43, 44 is associated with one parameter of the telecommunication network in question, i.e. its inputs are given by the measured values p1, p2, p3, or pn of the associated parameter. Depending on the occurrence and the nature of a detected network event the switches 41, 42, 43, 44 are either open or closed. In the open state the corresponding switch 41, 42, 43, 44 holds back the measured values p1, p2, p3, or pn forming its inputs. In the closed state the corresponding switch 41, 42, 43, 44 lets pass the measured values p1, p2, p3, or pn forming its inputs.

Hence, depending on the occurrence and the nature of the detected network event, not all measured values p1, p2, p3, pn are let pass by the measuring device 40. The different states of the switches 41, 42, 43, 44 in their various combinations form a set or sets of filter units. A set of filter units is e.g. given by the filtering device 40 with switch 41 closed and the remaining switches 42, 43, 44 open (first filter unit), the filtering device 40 with switch 42 closed and the remaining switches 41, 43, 44 open (second filter unit), the filtering device 40 with switch 43 closed and the remaining switches 41, 42, 44 open (third filter unit), and the filtering device 40 with switch 44 closed and the remaining switches 41, 42, 43 open (fourth filter unit). The second filter unit is exemplary depicted. The measured values p2 form the only output of the filter unit/filtering device 40. Thus, the measured values of the parameters of the telecommunication network can be reduced by the filter units/the filtering device 40. Filter units with other state combinations of the switches 41, 42, 43, 44 can be thought of.

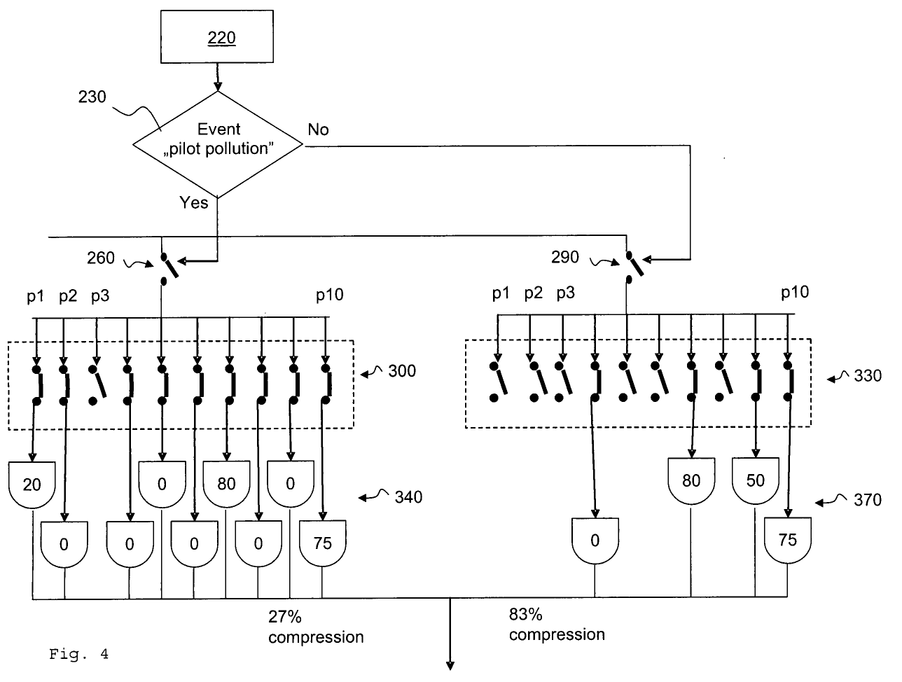

FIG. 4 shows an example of a flowchart of the method of the invention for the network event “pilot pollution”. For simplicity, the steps 20 and 21 and the database 38 are not shown in FIG. 4.

One of today's major issues when optimizing mobile networks of the third generation is to minimize areas with pilot pollution. Mobile phones in use today typically have a so called “rake” receiver with four fingers, of which one finger is used to scan pilot signals and the other three fingers are used for listening for “pilot signals”. In telecommunications a pilot signal is a signal, usually a signal frequency, transmitted over a communications system for supervisory, control, equalization, continuity, synchronization, or reference purposes (confer http://en.wikipedia.org/wiki/Pilot_signal). If a mobile phone is at a location where numerous pilot signals are received with relatively equal signal strength, then this is called pilot pollution. Pilot pollution can cause dropped calls and decreased capacity. Approaches for reducing pilot pollution include lowering cell site height, lowering cell site power and the use of repeaters. Moreover, mobile stations in CDMA (code division multiple access) or WCDMA (wideband code division multiple access) networks have the capability to communicate with several base stations whenever they are located in the fringe areas covered by overlapping base stations coverage areas. However, it is not desirable to receive pilot signals from a large number of base stations as this may cause pilot pollution interference and may overload the mobile station's rake receiver.

Step 220 of FIG. 4 corresponds to step 22 of FIG. 2 for the detection of the network event “pilot pollution”. In decision step 230 it is checked if the network event “pilot pollution” occurred. Exemplary the measured values of ten parameters p1 to p10 of the network in question are considered, namely:
p1—WCDMA finger data,
p2—WCDMA scanner info,
p3—TCP/IP (transmission control protocol/internet protocol) trace,
p4—WCDMA active set information,
p5—WCDMA path information,
p6—WCDMA finger correlation,
p7—HSUPA MAC (high-speed uplink packet access media access control) statistics,
p8—WCDMA neighbour set,
p9—GPS position, and
p10—WCDMA power control.

If the method of the invention is not employed, i.e. no selection of a particular filter unit takes place, then all measured data would be stored leading to a total amount of data of 48.52 Megabyte/hour. If with the method of the invention the network event “pilot pollution” is not detected (which may also be considered as the occurrence of the network event “default”), then the switch 290 is closed and default filter unit 330 is selected. The default filter unit 330 lets the measured values of the four parameters p4, p7, p9, p10 pass. The default compression unit 370 following the default filter unit 330 compresses the measured values of the parameter p7 with a compression rate of 80%, the measured values of the parameter p9 with 50% and the measured values of the parameter p10 with 75%. The default compression unit 370 does not compress the measured values of the parameter p4. For example, regarding the parameter p9 each second measured value, i.e. each second position, is removed leading to a reduction of the spatial resolution and, hence, to a reduction of the position accuracy. However, a high spatial resolution is first needed in case of the occurrence of the network event “pilot pollution”. In the example, an absolute data reduction rate of 87% is achieved, i.e. only 13.3% of the original measured values are let pass by the default filter unit 330 and the default compression unit 370.

The parameter p4 is preferably used as key performance indicator in steps 21, 220, 230 and if the measured actual value of the parameter p4 is larger than 3, then the network event “pilot pollution” is detected. In case of the detection of the network event “pilot pollution” the switch 260 is closed and the filter unit 300 is selected as pilot pollution filter unit. The filter unit 300 lets the nine parameters p1, p2, p4 to p10 pass for storage and evaluation. The parameter p3 is not required for analysis of the network event and, hence, not let pass. The tree parameters p1, p7 and p10 are then compressed by the subsequent compression unit 340. The parameter p1 is compressed with a compression rate of 20%, the parameter p7 is compressed with a compression rate of 80% and the parameter p10 is compressed with a compression rate of 75%. In the example the parameter p9 is not compressed, as the GPS position constitutes an important parameter when analysing the network event “pilot pollution”. In the example an absolute data reduction rate of 27% is achieved, i.e. 73% of the original measured values are let pass by the selected filter unit 300 and the selected compression unit 340.

The following table shows exemplary values for the embodiment shown in FIG. 4. The amount of data/measured values of the parameters before and after the application of the default filter unit 330 and after the default compression unit 370 and before and after the application of the selected filter unit 300 and after the selected compression unit 340 are given.

| | Measured Data, | | | | | | | | | |
|---|---|---|---|---|---|---|---|---|---|---|
| | unfiltered and | | | | | | | | | |
| | uncompressed, | | | | | | “Pilot Pollution” filter, event selected if | | | |
| | WCDMA HSxPA | | | | | | number of scrambling codes in p4 exceed | | | |
| | Data | | Default Filter | | | | a certain number (e.g 4) | | | |
| | Data Size | | Filter | Size after | | New Data | | Size after | | New Data |
| Parameter | [MB] | Data Size | unit | filter unit | Compression | Size | Filter unit | filter unit | Compression | Size |
| p1 | 14.04 | 28.9% | 0 | 0 | 0% | 0.00 | 1 | 14.04 | 20% | 11.23 |
| p2 | 9.34 | 19.2% | 0 | 0 | 0% | 0.00 | 1 | 9.34 | 0% | 9.34 |
| p3 | 9.18 | 18.9% | 0 | 0 | 0% | 0.00 | 0 | 0 | 0% | 0.00 |
| p4 | 5.78 | 11.9% | 1 | 5.78 | 0% | 5.78 | 1 | 5.78 | 0% | 5.78 |
| p5 | 4.35 | 9.0% | 0 | 0 | 0% | 0.00 | 1 | 4.35 | 0% | 4.35 |
| p6 | 2.82 | 5.8% | 0 | 0 | 0% | 0.00 | 1 | 2.82 | 0% | 2.82 |
| p7 | 1.03 | 2.1% | 1 | 1.03 | 80% | 0.21 | 1 | 1.03 | 80% | 0.21 |
| p8 | 0.93 | 1.9% | 0 | 0 | 0% | 0.00 | 1 | 0.93 | 0% | 0.93 |
| p9 | 0.82 | 1.7% | 1 | 0.82 | 50% | 0.41 | 1 | 0.82 | 0% | 0.82 |
| p10 | 0.23 | 0.5% | 1 | 0.23 | 75% | 0.06 | 1 | 0.23 | 75% | 0.06 |
| Total Datasize | 48.52 | | | 7.86 | | 6.45 | | 39.34 | | 35.54 |
| [Mbyte] | | | | | | | | | | |
| Percentage of | 100% | | | 16.2% | | 13.3% | | 81.1% | | 73.2% |
| data reduction | | | | | | | | | | |

The critical phase around the network event typically only takes a few seconds. Thus, it is uncritical/acceptable that more data/measurement values are stored with respect to this critical phase as for the default situation when no network event is detected. It is important that a high data reduction rate is achieved with the default filter unit during the default phase (i.e. when no network event is detected), preferably in connection with the default compression unit, as the default phase is usually the longer one during measuring.

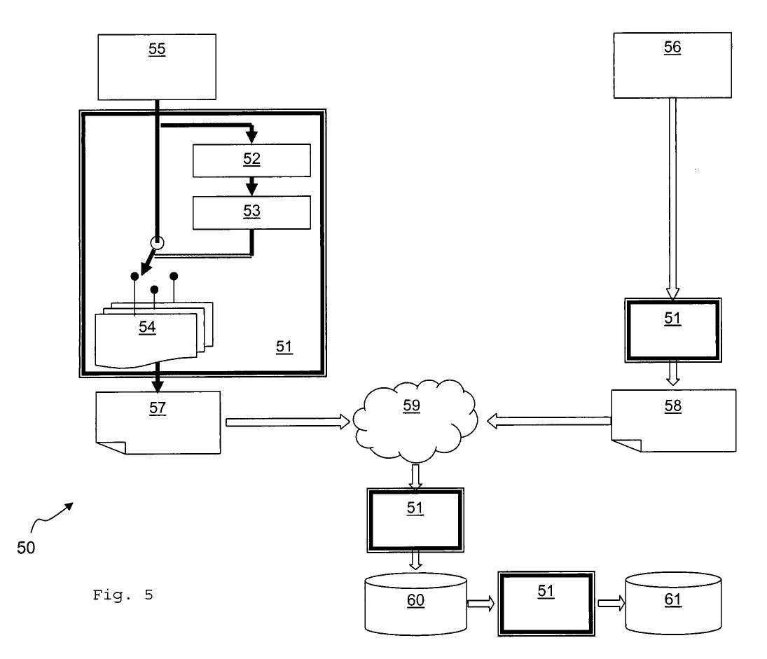

FIG. 5 depicts a schematic representation of a measurement setup 50 (comparable to the measurement setup 1 in FIG. 1) with an apparatus 51 according to the invention. The apparatus 51 of the invention may be realized as software and/or hardware component. On the apparatus 51 of the invention the method according to the invention as described with respect to FIG. 1 is implemented to be performed.

The apparatus 51 comprises a key performance indicator calculating unit 52 for calculating the actual values of the key performance indicators (as described with respect to step 21 of FIG. 2) and an network event detection unit 53 for network event detection (as described with respect to step 22 of FIG. 2). Furthermore, a set of filter units 54 is provided for filtering the measured values in dependence on the occurrence and nature of a network event. The set of filter units corresponds to the filter units 30, 31, 32, 33 of FIG. 2. The set of filter units 54 may be followed by a set of compression units (not depicted, confer FIG. 2: compression units 34, 35, 36, 37).

The measurement setup 50 furthermore comprises two measurement probes 55, 56 which basically correspond to the measurement probes 3, 5 of the measurement setup 1 of FIG. 1. The measurement probes 55, 56 can call each other and can exchange test sequences. With the measurement probes 55, 56 the measured values of the parameters of the telecommunication network are taken. The measured values of the parameters represent the measurement results and they can be stored in measurements files 57, 58 which correspond to the measurement files 7, 8 described in connection with FIG. 1. Via an upload channel 59 the measurement results can be uploaded into a database 60 which can be compressed—e.g. at a later time instance—to form a compressed database 61.

FIG. 5 shows various locations where the apparatus 51 according to the invention (which may be realined by software) may be positioned in the measurement setup 50 alternatively or in parallel. I.e. FIG. 5 shows various locations where the method of the invention can be performed within the measurement setup 50. The method of the invention is preferably performed by the apparatus 51 of the invention after the measured values have been taken by the measurement probes 55, 56 and before the measured values are written into the measurement files 57, 58 as measurement results. For this an apparatus 51 of the invention can be implemented on each of the measurement probes 55, 56, i.e. the method of the invention can be implemented on each of the measurement probes 55, 56. Of course, only one apparatus 51 can be provided which is assigned to one of the measurement probes 55, 56.

Furthermore, the method of the invention may be performed by the apparatus 51 of the invention before the measurement results written into the measurement files 57, 57 are stored in the database 60. Still furthermore, the method of the invention may be performed by the apparatus 51 of the invention before the entries of the database 60 are compressed to form a compressed database 61. Hence, the applications of the apparatus 51 and of the method of the invention are various within a measurement setup 50. The method of the invention and its corresponding apparatus 51 are preferably implemented just before locations where measurements results are collected (i.e. just before they are written in measurement files 57, 58 or into a database 60, 61).

It is to be understood that while certain embodiments of the present invention have been illustrated and described herein, it is not to be limited to the specific embodiments described and shown.

1. A method for processing measured values of parameters of a telecommunication network, wherein the measured values are filtered by a filter unit, and wherein the filter unit is selected from a set of filter units in dependence on the occurrence and the nature of a network event.

2. The method of claim 1, wherein the measured values are filtered such, that the measured values of certain parameters are held back, the parameters corresponding to the held back measured values being selected in dependence on the occurrence and the nature of the network event.

3. The method of claim 1, wherein the filtering of the measured values takes places before the measured values are stored in a database and/or a storage medium.

4. The method of claim 1, wherein the filtered measured values are compressed by a compression unit, which is selected from a set of compression units in dependence on the occurrence and the nature of a network event.

5. The method of claim 4, wherein the filtered measured values are compressed such that their resolution is reduced.

6. The method of claim 4, wherein the filtered measured values are compressed by averaging.

7. The method of claim 4, wherein the filtered measured values are compressed before they are stored in a database, and/or a storage medium.

8. The method of claim 1, wherein key performance indicators are defined for network event detection and a network event is detected if an actual value of a key performance indicator deviates from a predefined target value.

9. An apparatus for processing measured values of parameters of a telecommunication network, wherein a set of filter units is provided for filtering the measured values in dependence on the occurrence and the nature of a network event.

10. The apparatus of claim 9, wherein the filter units are formed such that the measured values of certain parameters are held back, the parameters corresponding to the held back measured values being selected in dependence on the occurrence and the nature of the network event.

11. The apparatus of claim 9, wherein a set of compression units is provided for compressing the filtered measured values in dependence on the occurrence and the nature of a network event.

12. The apparatus of claim 11, wherein the compression units are formed such that they perform averaging, in particular moving averaging, of the filtered measured values.
